(19) United States
(12) Patent Application Publication
(10) Pub. No.: US 2012/0016785 A1
(43) Pub. Date: Jan. 19, 2012

(54) Smart Matching for Synthetic Spreads

(75) Inventor: Sagy Pundak Mintz, Lincolnshire, IL (US)

(73) Assignee: TRADING TECHNOLOGIES INTERNATIONAL, INC., Chicago, IL (US)

(21) Appl. No.: 12/836,485

(22) Filed: Jul. 14, 2010

(51) Int. Cl. G06Q 40/00

(52) U.S. Cl. 705/37

(57) ABSTRACT

A smart match for synthetic trades may include monitoring working, or quoting orders, as well as legged hedge orders for one or more synthetic trades of a trader to identify possible matches prior to submitting a new order for trading. A resting (i.e., legged) hedge order for a synthetic trade of a trader may be pending execution while a second order from the synthetic trade, another synthetic trade, or an outright trade, may be identified. When the resting hedge order matches the second order, a cancel or delete message may be sent to the exchange for the resting hedge order, and the resting hedge order and second order may be matched or filled for the trader. When the resting hedge order is for a larger quantity than the second order, the message may delete or cancel a portion of the resting hedge order. If the quantity of the resting hedge order is for less than the second order, the message may be for the entire quantity of the resting hedge order, and a portion of the second hedge order may be submitted for trading.

### TECHNICAL FIELD

The present invention relates generally to electronic trading, and particularly to smart matching of orders for synthetic spread.

### BACKGROUND

Electronic trading systems have one or more networked computers, servers, gateways, processors, and related devices to couple a user (e.g., a trader) to one or more exchanges (also referred to as an electronic exchange, or host exchange). The exchange has one or more centralized computers for receiving, matching and processing orders from traders, other electronic trading systems and/or other exchanges for one or more tradeable objects traded, listed, and/or exchanged at the exchange. The exchange administers information for the tradeable objects and supplies, or broadcasts, the information via a real-time, or substantially real-time, streaming data feed, or other suitable form. The information generally includes at least a portion of an order book and order fill information. Traders may have one or more client devices connected to the electronic exchange for viewing the information and submitting orders.

A tradeable object includes an item or quantity of the item that can be traded, swapped of otherwise exchanged at a price, including but are not limited to, all types of traded events, goods, wares and/or financial product such as stocks, bonds, options, futures, commodities, currencies, repos, indexes, warrants, funds, derivatives thereof, collections or combinations thereof and the like. The tradeable object may be real, (i.e., listed by an exchange), or may be “synthetic” (i.e., a combination of real products).

The trader may employ one or more trading strategies for entering into trades for one or more tradeable objects. A complex trading strategy (known as a spread), includes simultaneous, or substantially simultaneous, buying and/or selling of one or more tradeable objects (also known as outright markets or legs). A spread may be exchange-defined or synthetic, where an exchange-defined spread is listed and priced as a whole, and a synthetic spread and its parameters are generally identified by the trader. Spreads may be inter- or intra-commodity and include a butterfly, bear, bull, calendar, crack, horizontal, vertical, basis, bundles, packs, strips, straddles, strangles, and ratio spreads.

A trader may use a trading tool to compile and present the information, define parameters of a spread, select a target spread price, enter orders, and re-price or requote a working order, in response to changes in the inside market for the hedge to achieve the target spread. The trading tool also may send a hedge order for the hedge leg at the inside market of the hedge leg based on the trader's parameters and/or the trading strategy. If the inside market for the hedge order does not change before the hedge order is received and executed, and there is sufficient quantity available for the hedge order, the hedge order can be filled. A portion of the hedge order that exceeds the quantity available at the inside market may not be filled. In addition, if the inside market changes, the hedge order may not be filled, at least not immediately, if at all. In this instance, the trader, and the spread, is said to be legged, because at least a portion of the hedge order (i.e., leg) did not get filled.

A spread may have multiple orders working in different markets where one or more of the orders may have resulted from a hedge order being legged (e.g., a leaned on quantity was gone before the hedge order reached the market or could otherwise be filled). On occasion, the trader may have another spread strategy that may place an opposite order (or contra order) at the same level as the legged order. In this instance, the opposite order may be sent to the exchange where it may be matched with the trader's hedged order or the opposite order may be matched with another trader's order at the price level of the hedge order, where the hedge order remains unmatched. Neither instance is desirable, because the trader may incur two matching fees (one for each order), potentially violate trading rules, and/or have a hedge order that could have been matched remain pending execution at the exchange.

Accordingly, there is a need for improved tools for assistance for a trader to employ synthetic spread trading strategies and smart matching of orders for the spread trading strategy.

### SUMMARY

Smart matching for synthetic spreads may include methods, systems, and apparatuses.

In an embodiment for smart matching for synthetic spreads, a new working order of a trader may be compared with pending orders. The new working order may be compared prior to submitting the new order for trading at an electronic exchange. In an example, the new order is compared to at least one pending order of the trader, where the new working order is for a first quantity for a tradeable object and the pending order is for a second quantity for the tradeable object. In response to the comparison, a determination is made that the new working order and the at least one pending order are contra orders and have a common price via the computing device. As such, a match is made between at least a portion of the first quantity of the new working order and at least a portion of the second quantity of the pending order and the match is reported.

The match may include a match between the full first quantity and a portion of the second quantity, a portion of the first quantity and the full second quantity, or the full first quantity and the full second quantity. The new working order and/or the pending order may derive from one or more synthetic spread orders, and/or may be outright orders.

As a result of matching a new hedge order may be submitted and/or a spread order may be reported as filled. In addition or alternatively, a cancel or delete message may be sent to an electronic exchange to cancel all of the pending order or a portion of the second quantity of the pending order that was matched.

Other embodiments are described below. In addition, modifications may be made to the described embodiments without departing from the spirit or scope of the invention.

### BRIEF DESCRIPTION OF THE FIGURES

Smart matching for synthetic spreads is described and illustrated via exemplary embodiments, which are not limited by the accompanying figures. Figures having like reference numerals indicate similar elements.

FIG. 1 illustrates an exemplary electronic trading environment for smart matching for synthetic spreads.

FIG. 2 illustrates a flowchart for an exemplary method for facilitating synthetic spread trading.

FIG. 3 illustrates a flow chart for an exemplary method for filling and executing trades for synthetic spread trading.

FIG. 4 illustrates a block diagram for synthetic spread trading.

FIG. 5 illustrates an example of a trading strategy having multiple spreads.

FIG. 6 further illustrates the example of the trading strategy of FIG. 5 where the multiple spreads have been launched at corresponding working orders have been submitted.

FIG. 7 further illustrates the example of FIGS. 5 and 6 where the order for one leg of a spread has been filled, and a hedge order for has been submitted.

FIG. 8 further illustrates the example of FIGS. 5, 6, and 7 where a new order is compared for a match to existing orders.

FIG. 9 illustrates an example of a spread configuration window.

### DETAILED DESCRIPTION

### I. Electronic Trading Environments

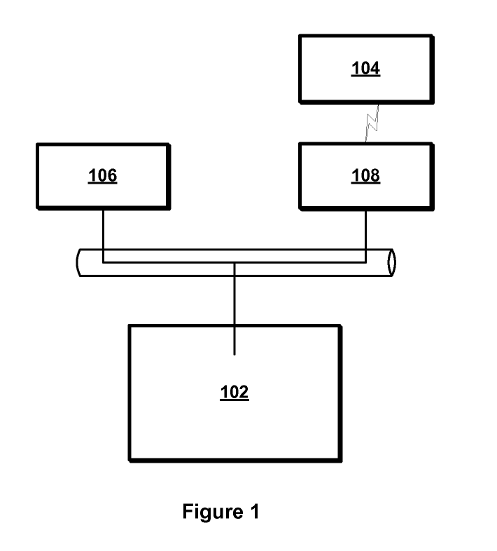

FIG. 1 illustrates an exemplary electronic trading environment for smart matching for synthetic spreads. The electronic trading environment includes a client device 102, a gateway 106, an electronic exchange 104, and a router 108. The client device 102 is operatively coupled with the electronic exchange 104 through one or more devices such as the gateway 106 for communication of information. Router 108 is configured to route messages between the gateway 106 and the electronic exchange 104.

The electronic exchange 104 may list one or more tradeable objects for trading. The electronic exchange 104 includes at least one processor, or central computer for receiving and matching orders from client devices 102 against contra orders. An order for a tradeable object that is not immediately matched may be stored and arranged in an order book for order matching according to a match algorithm for the tradeable object. The electronic trading environment may include various electronic trading environments having the same, additional or alternative features.

The electronic exchange 104 also may distribute or broadcast information related to orders pending at the electronic exchange 104 and orders matched at the exchange or other exchanges. The information may include data representing a current inside market (e.g., the lowest sell price (best ask) and the highest buy price (best bid)). The information also may include all or a portion of the market depth, which may include quantities of the tradeable object available at the inside market and/or quantities of the tradeable object available at prices away from or outside of the inside market, to the extent that such quantities are available. The information also may include news, charting data, and/or order-related information from an exchange or other data source.

A quantity available at a price level may be provided in aggregate sums, where a total buy quantity and a total sell quantity available in the market at a price level is provided. The extent that the market depth is provided generally depends on the exchange and/or other parameters, such as volume. Other types of information, such as the last traded price (LTP), last traded quantity (LTQ), and order fill information also may be provided. Information related to order fills (also referred to as order execution, and order completion) may be referred to as market data.

The client device 102 may be one or more devices such as multiple work stations or a network of devices and may execute one or more applications. Examples of the client device 102 include one or more mainframe, desktop, notebook, tablet PC, handheld, personal digital assistant, Smartphone, server, gateway, combination thereof, or other computing device having one or more processors or central processing units. For example, the client device may be include a Pentium® class processor and/or may use one or more of a Windows® or MAC OS operating system, and include one or more memory or data storage devices, an data input interface for receiving data from a communications network, a user input interface for receiving input signals from one or more input devices, such as a keyboard, a trackball, pen device, microphone, gazing detection device, mouse for click-based trading and/or other device for configured to receive input from a user, and an output interface for communications with at least one output device (e.g., a monitor or display device, audio device, or combination thereof) suitable for presenting information.

The client device may receive and display the market information from one or more exchanges or other sources. For example, the display device may include a CRT-based video display, an LCD-based or a gas plasma-based flat-panel display, a display that shows three-dimensional images, audio devices, and/or Braille output devices or some other type of output device or mechanism. The display device may include an input device to provide for interaction between the user and the information.

The client device 102 may be used by a user, or a trader, to submit one or more orders for one or more tradeable objects for trading. An order may include instructions or messages to place or submit a new order, cancel an existing order, change an existing order, initiate query about orders or order book for one or more tradeable objects, test a connection to, or communication with, an exchange, combinations thereof and the like. A trader may send an order, such as by supplying one or more commands using one or more input devices associated with the client device, including a keyboard, a mouse or pointing device, a portion of the display, touching or controlling an area of the display or area controlled by the display. The client device 102 may generate transaction information in response to the user input, which may be sent to one or more exchanges.

Instructions for carrying out acts for smart matching for synthetic spreads may be stored or otherwise recorded on a computer readable medium, such as non-volatile media, volatile media and transmission media, including floppy disks, flexible disks, hard disks, magnetic tape, punch cards, CD-ROM, a RAM, a PROM, an EPROM, a FLASH-EPROM, and any other memory chip or cartridge, or medium from which a computer can read. The processor may have sufficient processing capability for available market information and for carrying out the acts. In an exemplary embodiment, software may administer interactive trading screens on display devices for viewing the market information, entering and submitting orders, obtaining market quotes, and monitor positions. Additionally or alternatively, the client device may automate trading.

An example of such trading tool includes X_TRADER® by Trading Technologies International, Inc. of Chicago, Ill., and may also include an electronic trading interface, referred to as MD Trader®. Portions of the X_TRADER and the MD Trader style display are described in U.S. Pat. No. 6,772,132 for a “Click Based Trading With Intuitive Grid Display of Market Depth,” U.S. Pat. No. 6,938,011 for a “Click Based Trading with Market Depth Display” U.S. Pat. No. 7,127,424 for a “Click Based Trading With Intuitive Grid Display of Market Depth and Price Consolidation,” U.S. Pat. No. 7,389,268 for “Trading Tools For Electronic Trading,” and U.S. Pat. No. 7,228,289 for “A System and Method for Trading and Displaying Market Information in an Electronic Trading Environment,” U.S. Pat. No. 7,437,325 titled “System and Method for Performing Automatic Spread Trading,” U.S. patent application Ser. No. 12/637,517, filed Dec. 14, 2009 and titled Synthetic Spread Trading, and U.S. patent application Ser. No. 12/637,536, filed Dec. 14, 2009 and titled Cover-OCO Orders for a Legged Order, the contents of each are incorporated fully herein by reference. In addition or alternatively, other trading tools may be used for smart matching for synthetic spreads.

The gateway 106 may be a computing device having one or more processors or central processing units, memory or data storage devices, communication interfaces, user input interfaces, and output interfaces. The gateway 106 may include or access a database. The gateway may execute one or more gateway applications, the gateway 106 may execute application programs of the client device 102, and/or the gateway applications may be performed by the client device 102.

The electronic trading environment may include one or more electronic exchanges 104 at which a trader may trade. The client device 102 may access the one or more electronic exchanges 104 through one or more gateway 106, and/or a combined gateway that provides access to multiple electronic exchanges. In addition or alternatively, router 108 may routes data between gateways and electronic exchanges.

### II. Spread Trading

In general, a complex trading strategy involve multiple tradeable objects is referred to as a spread. Each of the tradeable objects, orders or potential orders for each tradeable object, may be referred to as a leg or outright. A trade for a spread may be considered a buy or sell of the spread, where a buy defines which leg of the spread is bought—typically the first or front leg—a sell defines which leg is sold—also typically the first or front leg.

The spread may be based on a defined, or known, relationship between tradeable objects, such as a spread ratio, which indicates the quantity of each leg in relation to other legs of the spread. For example, a spread having legs A and B may be defined by a 3:2 ratio, where 3 units of leg A may be bought and 3 units of leg B are sold. The spread ratio may be implied, or implicit such that the spread ratio for a leg of a trading strategy is not be explicitly specified, but rather implied or defaulted to be “1” or “−1” (a positive nomenclature denotes bought leg and negative nomenclature denotes a sold leg).

One or more legs of the spread may also have a multiplier for a price relationship. The multiplier may be the same as or different from the spread ratio. For example, the multiplier associated with leg A may be “2” and the multiplier associated with leg B may be “−3,” both of which match the corresponding spread ratio for the legs.

In an example, a trading strategy includes “N” legs, where the relationship between tradeable object is defined according to spread ratio and multiplier associated with each leg. A strategy price, or target price, also may be determined according to the definition of the trading strategy. The price is considered the sum of price of the tradeable object multiplied by the multiplier for each of the legs, as follows:

Strategy Price=Σᵢ₌₁^{N}Mult(i)*Price(i) Eq. 1

Where Mult(i) is the multiplier associated with leg i and Price(i) is the price for the tradeable object for leg i. One skilled in the art will also recognize that the price for a trading strategy may be affected by price tick rounding and/or pay-up ticks.

Orders for each leg may be submitted according to parameters and/or relationship defined by the trading strategy. As an example, a market for one unit of Leg A has a price of 45, and the market for Leg B has one unit at a price of 40. The current spread price, using Equation 1, would then be (1)(45)+(−1)(40)=5. Thus, a trader that buys 1 unit of the spread, buys 1 unit of Leg A at a price of 45 and sells 1 unit of Leg B at 40.

If the typical price difference is restored, such as where price of Leg A is 42 and the price of Leg B is 32, the price of the spread would be 10. If the trader sells 1 unit of the spread to close out the position (that is, sells 1 unit of Leg A and buys 1 unit of Leg B), the trader may profit on the total transaction. That is, the trader bought Leg A at 45 and sold at 42, losing 3, the trader also sold Leg B at 40 and bought at 32, for a profit of 8. Thus, the trader made 5 on the buying and selling of the spread.

Generally, a spread strategy may be based on a desired price where one or more legs are bought and/or sold at appropriate prices using an automated spread trading tool that administers trades according to the strategy. For example, a trader may enter an order to buy or sell a trading strategy at a price (also referred to as a desired strategy price, desired spread price, desired price and/or a target price), and the automated trading tool may automatically place an order (also referred to as a quoting, or working order) for at least one of the tradeable objects to achieve the price for the trading strategy.

The leg for which the order is placed is referred to as the quoting leg and the other leg is referred to as a lean leg and/or a hedge leg. The quoting leg is said to lean on the hedge leg. The price that the quoting leg is quoted at, or working at, is based on the best price that an order could be filled at in the hedge leg, which is typically at the inside market of the hedge leg. That is, the best price is typically the best bid price of the hedge leg when selling and the best ask price of the hedge leg when buying. The best price in the hedge leg is also known as the leaned on price, lean price, or lean level. The trading strategy may be quoted in a single quoting leg or in multiple (or even all) legs of a spread where each quoted leg leans on at least one of the other legs of the spread. When one of the quoted legs is filled, the orders in the other quoted legs are typically cancelled and appropriate hedge orders are placed.

As the leaned on price changes, the price for the order in the quoting leg may also change in order to maintain the desired strategy price, and/or may change according to changes in the hedge leg being within a limit, or would result in a change to the quote leg within a limit. When the quoting leg is filled, the automated trading tool may submit an order in the hedge leg to complete the strategy, also referred to as an offsetting or hedging order.

The price of a quoted leg may also or alternatively be based on less than all of other legs of a spread. The order parameters of an order in a quoted leg may lean on other types of market conditions in the other legs such as the last traded price (LTP), the last traded quantity (LTQ), a theoretical value, multiple quantities such as quantities closer to the inside market, or some other reference point.

When a quoting leg is filled, but at least one of the hedge legs cannot be filled, (or filled sufficiently to achieve the desired price of the trading strategy) the spread may be determined to be legged. The hedge leg may not be filled because the inside market for the hedge moved away before the hedge order was entered, and/or there may not be sufficient volume to fill the order at the inside market.

### III. Spread Trading Tool

The orders and fills for the synthetic spread, including the orders for each leg of the synthetic spread, may be managed, compiled, recorded, viewed and the like through one or more spread trading tools, such as Autospreader. A spread trading tool may be used to view market information for the spread and its legs, administer the strategy for trading the legs (outright or working orders) and/or sending orders in one or more legs.

The spread trading tool also may generate spread data based on information for its constituent legs and spread parameters. The data may be formatted and presented in a visual format, such as in a graphical user interface manager (“GUI manager”). That is, the data for the spread and/or data for one or more legs of the spread may be displayed in one or more windows for the spread and/or using the GUI. The data for the spread and the data for each leg may be displayed in the same or different windows. Orders can be entered or submitted for trading in the spread window, and the spread trading tool will submit and/or initiate submission of corresponding orders according to the spread to obtain the desired or target price of the spread.

An exemplary a spread trading tool is provided in U.S. Pat. No. 7,437,325 for “System and Method for Performing Automatic Spread Trading,” U.S. patent application Ser. No. 10/804,631 for “System and Method for Estimating a Spread Value,” filed Mar. 19, 2004, U.S. Pat. No. 7,389,264 for “System and Method for Performing Automatic Spread Trading,” U.S. Pat. No. 7,424,450 for “System and Method for Performing Automatic Spread Trading,” U.S. patent application Ser. No. 12/410,759 for “Systems and Methods for Multiplier-Adjusted Lean Levels for Trading Strategies, filed Mar. 25, 2009, all of which are incorporated fully herein by reference. Other spread trading tools may be used and the described embodiments are not limited to any particular product.

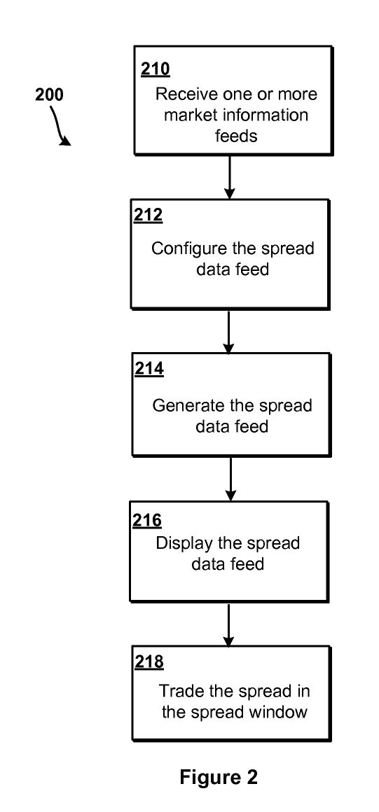

FIG. 2 illustrates a flowchart 200 for an exemplary method for facilitating spread trading. The method is exemplary and may include more or fewer acts, may occur an order different from that shown. In the exemplary embodiment, market information feeds are received 210 from one or more exchanges for one or more tradeable objects. The market information generally includes the price, order, and may include fill information for one or more tradeable objects the inside market for the tradeable object, including the highest bid price (HBP) and the lowest ask price (LAP), in addition to current bid and ask prices and quantities in the market at other prices, referred to as “market depth.” The information may include all or some of the market depth.

The spread data also may be configured, established and/or presented 212 according to user preferences. For example, the user may customize an estimation of spread prices and spread market depth based on bids and offers from markets for the legs and the spread setting parameters. The user also may re-configure existing spreads, and/or create new spreads to configure by selecting the legs for the spread. The legs may be selected, and the spread configured, according to spread setting parameters in a configuration window. The user also or alternatively may determine a relationship between legs, order submission for a leg, and/or administration for orders for a leg.

The spread trading tool may generate the spread data 214 based on the market information and the spread setting parameters. The spread data may include spread prices and spread depth. The spread data may also include the last traded price (LTP) and/or the last traded quantity (LTQ), in addition to other items such as open, close, settlement, daily high/low, periodic high, market depth, market snapshots, and the like. The data may be included according to parameters set, identified or otherwise selected by the user, limits of the exchange from which the market data feed came, and the like. Generating a spread data may occur on a real-time basis, or substantially real-time basis, where information that is relayed from the market is presented to the user as soon as feasible. For example, the information is processed and presented within a sufficient or reasonable amount of time to display the information. Additionally or alternatively, the spread data may be generated on a periodic time or semi-periodic time basis.

A spread window is generated and displayed 216, which also may include a window for each corresponding leg of the spread. The spread window may display a spread price and an indicator for the total quantity as well as the LTP/LTQ.

Orders for the spread, and its legs, may be entered 218 for a desired quantity at a target price in the spread window. In an example, an order is entered according to manipulating one or more input devices, such as a mouse, keyboard, light pen, combinations thereof and the like to cause an input indicator (e.g., a cursor) to position the cursor relative to the desired quantity and/or target price. The desired quantity additionally or alternatively may be preset, predefined, predetermined, or preselected.

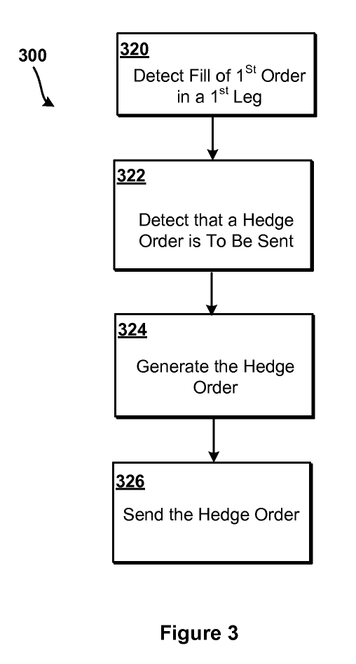

FIG. 3 illustrates a flow chart for an exemplary method for filling and executing synthetic spread trades. The method is exemplary and may include more or fewer acts, may occur an order different from that shown. In the example, an order for one leg is working (quoting or being quoted) at an exchange and corresponds to a first tradeable object. A complete or partial fill, match or execution, at the exchange for the quoting order is detected 320, and a hedge order is determined 322. In response to the fill of the quoting order, the hedge order is generated at 324, and is sent to the exchange for the tradeable object of the hedge order 326. The electronic exchange for the hedge order may be the same or different electronic exchange. Order parameters for the hedge order, such as a hedge order price, may be determined to achieve the spread price.

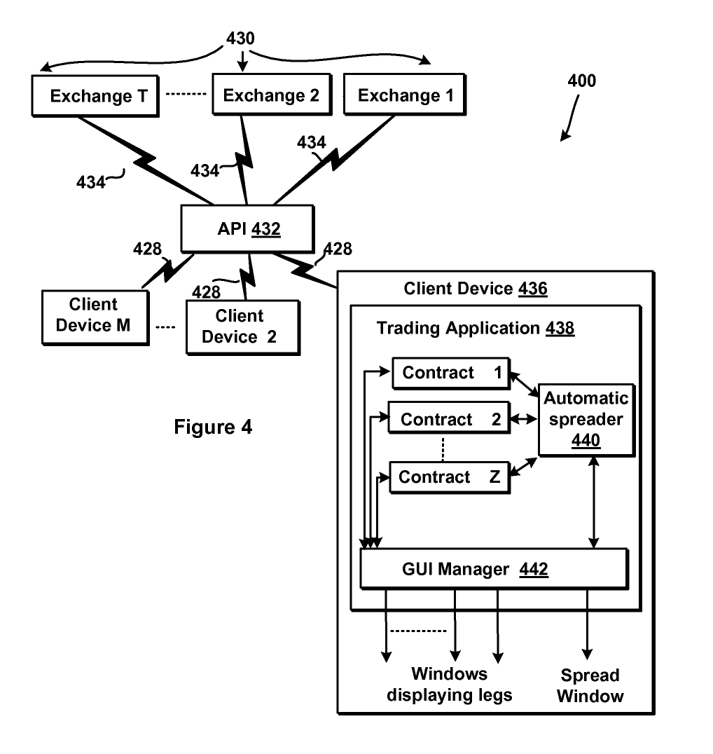

FIG. 4 illustrates a block diagram for a synthetic spread trading system 400 having an applications program interface (“API”) 432, exchanges 430, client devices, communications 428 between the API 432 and client devices, and communications 434 between the API 606. The communications 434,428 may include information and data concerning tradeable objects which is generally translated by the API 432. The GUI manager 442 may be employed with an input device for receiving commands from a user. The system is generally unlimited in the number of exchanges and client devices.

Client device 436 further illustrates a more detailed block diagram having a trading application 438, an automatic spreader 440, and GUI manager 442, all or any of which may be implemented with software, hardware, or a combination thereof. Fewer or more components may be included and the trading application 438 and automatic spreader 440 may be hosted on the client device 436 or other device, may be the same software or separate software applications on the same or different client devices 436.

The automatic spreader 440 generates spread data based on market information for one or more tradeable objects and provide the information in a spread window. The spread data may include spread price and market depth and may include other items, such as the last traded price (LTP) and the last traded quantity (LTQ), high price, low price for a time or period of time and the like.

### IV. Spread Trading

Smart matching for synthetic spreads may identify a match between a resting (i.e., legged) hedge order and a subsequent order derived from the same or different synthetic trade order prior to submitting the subsequent order for trading. Similarly, a match between a resting (i.e., legged) hedge order and an outright trade order of the trader may be identified prior to the subsequent order being submitted.

In an example, a trader may be working multiple synthetic spreads, where at least one leg is overlapping. In an embodiment, the orders are monitored to identify potential matches prior to submitting a new order for trading. For example, working orders (i.e., quoting orders), as well as legged hedge orders for one or more synthetic spreads, may be monitored to identify possible matches to other orders of the trader. A hedge order for a synthetic trade may be resting in an order book and pending execution (i.e., a legged hedge order) while a second order from the synthetic spread, another synthetic trade, or an outright order may be identified as a potential match against the legged hedge order. In response to determining that the legged hedge order matches the second order, a cancel or delete message may be sent to the exchange for the legged hedge order, and the legged hedge order and second order may be matched, or filled, and/or reported to the trader as being filled. The message may delete or cancel a portion of the legged hedge order according to the legged hedge having a larger quantity than the second order. The message may apply to the entire quantity of the legged hedge order, and a portion of the second hedge order may be submitted for trading according to the quantity of the legged hedge order being less than the second order.

In another example, a single trading strategy has at least two legs being quoted with orders in each leg being monitored to identify possible matches prior to a new order being submitted for trading. For example, a hedge order in the first leg may be legged while a quoting order to be submitted for the first leg has been identified as a possible match against the legged hedge order. In response, a cancel or delete message may be sent to the exchange for all or a portion of the legged hedge order, and all or a portion of the legged hedge order and all or a portion of the second order may be matched or filled for the trader and/or reported to the trader as being filled. The spread from which the legged order may be considered filled or partially filled according to the amount of the legged order that was matched.

In another or alternative embodiment, one or more order may be pending execution and identified as a match for a new order that may be submitted for trading. The new order may be an outright order or derived from one or more trading strategies involving trades for one or more tradeable objects. As such, the orders may be matched in or partially, and reported as a match.

In another example, multiple traders may each be working one or more orders and/or synthetic spreads from within a firm and/or trading desk. The multiple orders may be monitored and/or reviewed prior to submitting a new order for trading. When one or more of the working orders are identified as a match prior to submission of the new order, a match may be identified and reported.

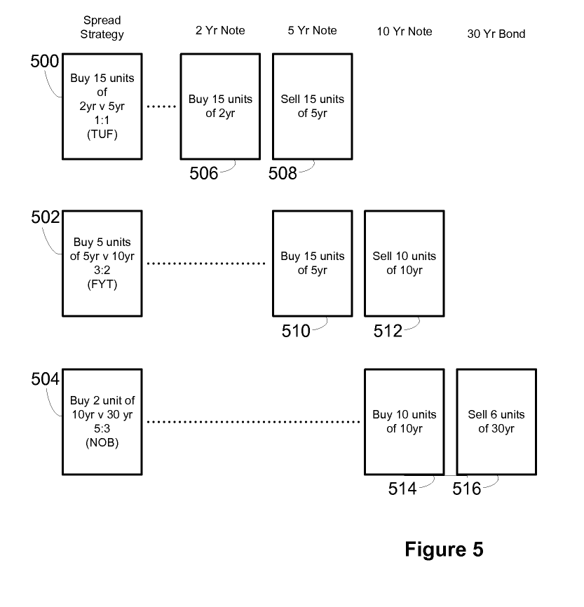

FIG. 5 illustrates an example of multiple spreads 500, 502, 504 for a trader, where each spread includes multiple legs 506, 508, 510, 512, 514, and 516. Spread 500 is between a 2 year note and a 5 year note, spread 502 is between the 5 year note and the year note, and spread 504 is a spread between the 10 year note and the 30 year bond. For clarity and simplification, 15 units of spread 500, 5 units of spread 502, and 2 units of spread 504 are each being bought, and only the first leg of each spread 500, 502, and 504 is being quoted. Spread 500 (2 yr. v. 5 yr., or “TUF”) includes leg 506 for the 2 year note and leg 508 for the 5 year note, spread 502 (5 yr. v. 10 yr., or “FYT”) includes leg 510 for the 5 year note and leg 512 for the 10 year note, and spread 504 (10 yr v. 30 yr., or “NOB”) includes leg 514 for the 10 yr note and leg 516 for the 30 yr bond. The example of FIG. 5 shows that spread 500 has a ratio of 1:1, spread 502 has a ratio of 3:2, and spread 504 has a ratio of 5:3. One skilled in the art will understand that features and embodiments for smart matching for synthetic spreads apply to any combination of spreads, legs, tradeable objects, outright orders, sides of the spreads, number of units, ratios, multipliers, number of orders, number of legs being quoted combinations thereof and the like.

Because the example includes a buy of each spread 500, 502, and 504 and only the first leg in each spread is being quoted, when an order for the spread is launched, or otherwise submitted, a buy order is placed in the first leg of the corresponding spread for a quantity based on the ratio for the spread and the quantity for the buy order of the spread. The buy order for the first leg may be at a price determined according to a price for the order for the spread and an inside market for the second leg. For example, when an order to buy 15 units of spread 500 is placed, an order for leg 506 for the 2 year note is submitted at a price determined according to the buy price for the spread 500 and the inside market for leg 508 for the 5 year note, and more particularly, the highest bid price in the market for leg 500. According to the example, spread 500 is set up to have a 1:1 ratio, and therefore when the buy order for 15 units of spread 500 is placed, a buy order for 15 units of leg 506 for the 2 yr note is submitted. An eventual hedge order for leg 508 for the 5 year note will be for 15 units.

When a buy order for 5 units of spread 502 is entered, a buy order for leg 510 for 15 units of the 5 year note is submitted at a price determined according to the price of the buy order for the spread 502 and the inside market of leg 512 for the 10 year note. In response to entry of a buy order for 2 units of spread 504, a buy order in leg 514 for the 10 year note is submitted for 10 units at a price determined according to the price for the buy order for spread 504 and the inside market for leg 516 for the 30 year bond. As such, after entry of the spreads 500, 502, 504 orders for legs 506, 510, 514 are submitted, based on the inside markets of respective hedge legs 508, 512, 516. The submitted orders in legs 506, 510, 514 are considered working. If one or more of the submitted orders in legs 506, 510, 514 are filled, completely or in part, one or more corresponding hedge orders in the associated hedge leg 508, 512, 516 may be submitted for execution. Thus the example of FIG. 5 includes buying 15 units of 2 year note, selling and buying 15 units of the 5 year note, selling and buying 10 units of the 10 year note and selling 6 units of the 30 year bond.

FIG. 5 illustrates an overall strategy including spreads 500, 502, 504 have two overlapping legs where leg 508 for the 5 year note of spread 500 overlaps 510 of the 5 year note of spread 510, and leg 512 for the 10 year note of spread 502 overlaps leg 514 of spread 504. For the sake of clarity and simplicity, the example shows 2 overlapping legs. Features and embodiments for smart matching for synthetic spreads apply to any number of spreads and outright orders.

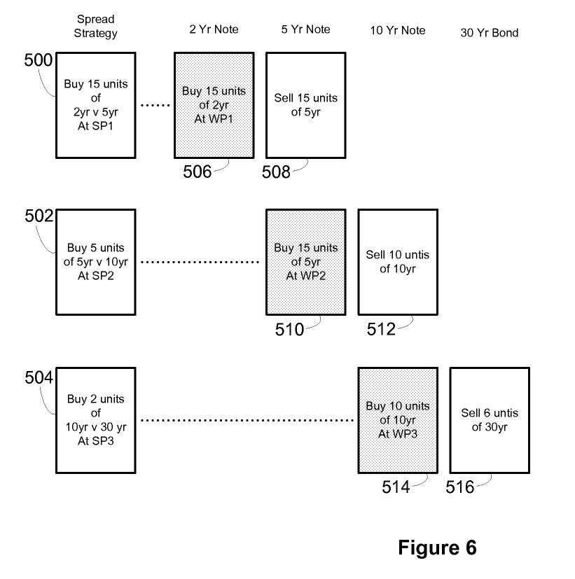

FIG. 6 illustrates an example where orders for 15 units of spread 500 at a price of SP1, 5 units of spread 502 at a price of SP2, and 2 units of spread 504 at a price of SP3 have been entered, or otherwise launched, to buy the corresponding spread. Corresponding orders have also been submitted for trading or execution in the working or quoting legs of the spreads 500, 502, 504. As such, FIG. 6 illustrates that an order has been submitted in leg 506 to buy 15 unit of the 2 year note at a price of WP1, an order has been submitted in leg 506 to buy 15 units of the 5 year note at WP2, and an order has been submitted in leg 514 to buy 10 units of the 10 year note at WP3.

In the example, none of the orders for legs 506, 510, 514 have been filled, in whole or in part and the orders for legs 506, 510, 514 may be considered executable and/or pending in one or more order books for one or more electronic exchanges and/or electronic communication network (ECN) for the tradeable object of the order. When some or all of the order for one or more of the orders for legs 506, 510, 514 are filled, one or more corresponding hedge orders may be submitted for execution. For example, as the market for a leg moves, a corresponding working order for the leg may be executed in full or in part. Depending on the amount of the order that is filled, and on the parameters of the spread, an order for the corresponding hedge leg may be identified.

In an embodiment for smart matching for synthetic spreads, orders including pending working orders, hedge orders and outright orders may be monitored to identify potential matches with new orders that may be derived from one or more synthetic spreads and/or outright order. For example, a potential match between a legged hedge order and a working order may be identified, a potential match between multiple outright orders may be identified, a potential match between multiple legged orders may be matched, any combinations thereof, combinations now known and/or later developed.

The working order may be for the same spread, or for another spread. Additionally or alternatively, a match may be identified between a working order, a legged hedge order and/or an outright order. In an embodiment, the potential match may be identified by one or more trading tools, components thereof, or feature thereof. An example of such trading tool is Autospreader® of Trading Technologies International, Inc. of Chicago, Ill.

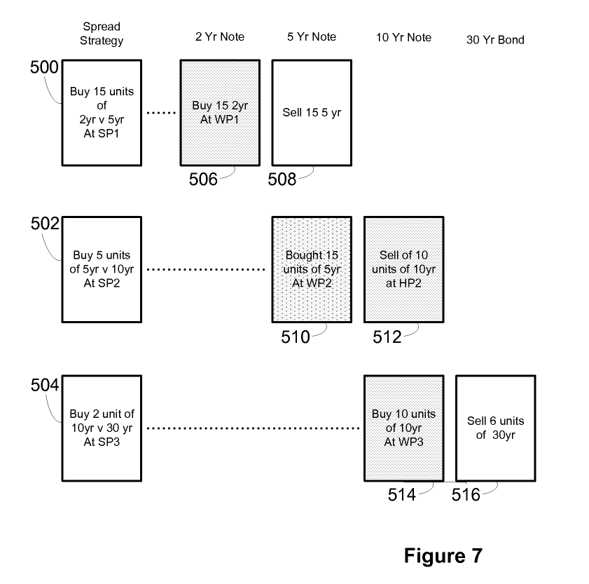

FIG. 7 illustrates the example of FIGS. 5 and 6 where the order for leg 510 for the 5 year note of spread 502 has been filled and the hedge order for leg 512 for 10 units of the 10 year note has been submitted at HP2. In the example, the inside market for hedge leg 512 may have moved such that there is insufficient quantity at the inside market to fill all or some of the order for hedge leg 512. As such, all or some of the order for leg 512 is unfilled, entered in the order book for the 10 year note, and pending execution. The order for hedge leg 512 also may be considered legged. In the example, none of the quantity for hedge leg 512 was filled, and the order for hedge leg 512 is for 10 units of the 10 year note at a price of HP2.

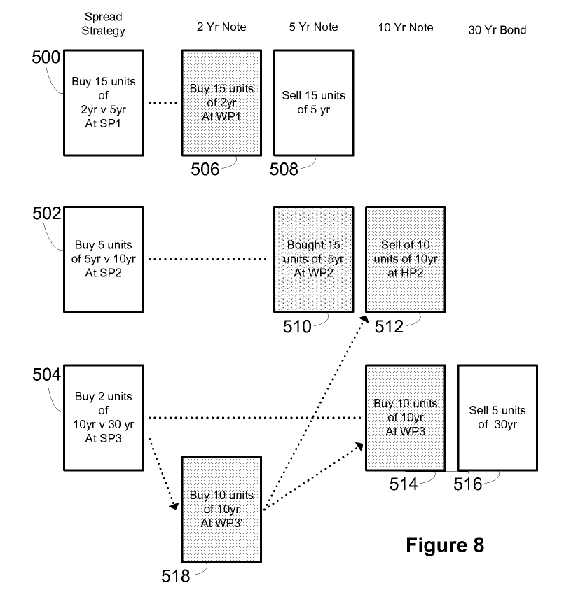

FIG. 8 illustrates the example of FIG. 7 after a determination has been made to requote leg 514 for the 10 year note of spread 504. For example, a spread trading tool such as Autospreader may have been used to launch spread 504, and submit the order for leg 514. The trading tool also may be set up or configured to requote the order for leg 514 according to changes in the inside market for the hedge leg 516. For example, the order for leg 514 may be requoted for every change in the inside market, if the inside market changes more than a number of ticks or percentage in one more directions (e.g., up and/or down), if another market changes, combinations thereof and the like.

When an order is identified to be requoted a new order may be generated at a new price based on the price at which the spread was entered or launched and the new inside market of the hedge leg. The spread trading tool may submit a cancel/replace order that submits a new order at the new price and deletes or cancels the previous working order. Additionally, or alternatively, the spread trading tool may submit a price change to the working order to change the price of the working order to the new price.

FIG. 8 illustrates a new order 518 that may be submitted at a new price WP3′ for leg 514 of spread 504. The price WP3′ may be determined based on the spread price at which the spread 504 was launched and the inside market, or changes to the inside market for the hedge leg 516. Prior to submitting the new order 518 at price WP3′, the new order 518 may be compared to one or more existing orders in the market for the tradeable object of the new order 518.

In the example, the new order 518 is a buy order for 10 units for the 10 year note at a price of WP3′. As such, the new order 518 is compared to other orders for the 10 year note. The other orders may be legged hedge orders of a spread, working orders of a spread, outright orders of the spread and the like. In the example of FIG. 8, the new order 518 is compared to the legged hedge order for leg 512 of spread 502 to determine whether the new order is a match. To determine whether the new order 518 and the legged hedge order for leg 512 are a match the quantities of each order and the price of each order may be compared. As such, a match may be identified if the price of the new order WP3′ matches the price HP2 or if the match between the orders provides a better match for the trader. In addition or alternatively, a match may be identified if the price of the new order WP3′ is within a tolerance or range of the price HP2. For example, the trader may be willing to match the order if the price of the new order is within 3 ticks of existing orders, and/or within a percentage price of the existing or new order. The tolerance or range also may be determined according to an algorithm, formula, time, price or the order and combinations thereof and/or later developed. A match also may be a full match where the full quantities one or both orders are matched, or partial where the quantity of at least one of the orders is not fully matched.

In the event that prices WP3′ and HP2 match, the orders and/or the available quantity between the orders is matched. In an embodiment, when the quantity of the new order 518 matches the quantity of the legged hedge order for leg 512, the legged hedge order for leg 512 and the working order for leg 514 will be cancelled, or otherwise deleted, and a fill will be reported for both the legged hedge order and the new order 518. Because the working order for leg 514 and the legged hedge order for leg 512 are both considered filled, a corresponding hedge order for leg 516 will be submitted and the spread 502 may also be considered filled. In the example of FIG. 8, because the new order 518 is to buy 10 units and the legged hedge order for leg 512 is also for 10 units, and price WP3′ matches price HP2, the new order 518 is considered a full match to the legged hedge order for leg 512.

In the event that the new order 518 may be matched, but is for a larger quantity than can be matched prior to sending the new order 518 for trading, a portion of the new order 518 that may be matched is considered filled and a remaining portion of the new order 518 is submitted for trading. Because a portion of the new order 518 may be filled, a corresponding hedge order also may be submitted for trading. In addition, the order against which the portion of the new order 518 was matched will also be deleted or otherwise cancelled and reported as filled.

In the event that the new order 518 is not for a sufficient quantity for a complete match between orders, the new order 518 may be considered matched and reported as a fill. A portion of the order against which the new order 518 was matched is deleted or otherwise cancelled. A remainder portion of the order against which the new order 518 was matched remains pending.

The new order 518 also or alternatively may have been derived from a change in the spread from which the new order 518 derived. For example, a price for spread 504 may have been changed and new order 518 determined to be submitted for trading. The price for spread 504 may have been changed, for example, by moving an indicator for the spread 504 in a window along an axis of prices from the old price at which the spread 504 was originally launched to the new price for the spread. In addition or alternatively, the spread 504 may be cancelled and relaunched at the new price. As such, the new order will be compared to existing orders for a potential match, prior to the order being submitted.

In another or alternative embodiment, the new order 518 may derive from an outright order. For example, the new order may derive from a trader entering an order for the 10 year note at price WP3′. Prior to submission, the new order 518 compared to other orders of the trader to identify a potential match for all or a portion of the quantity of the new order 518.

One skilled in the art will recognize that the above embodiments for smart matching for synthetic spreads apply to other types of orders. For example, smart matching may apply to outright orders, to a different leg of the same spread and the like.

### V. Smart Matching Configuration

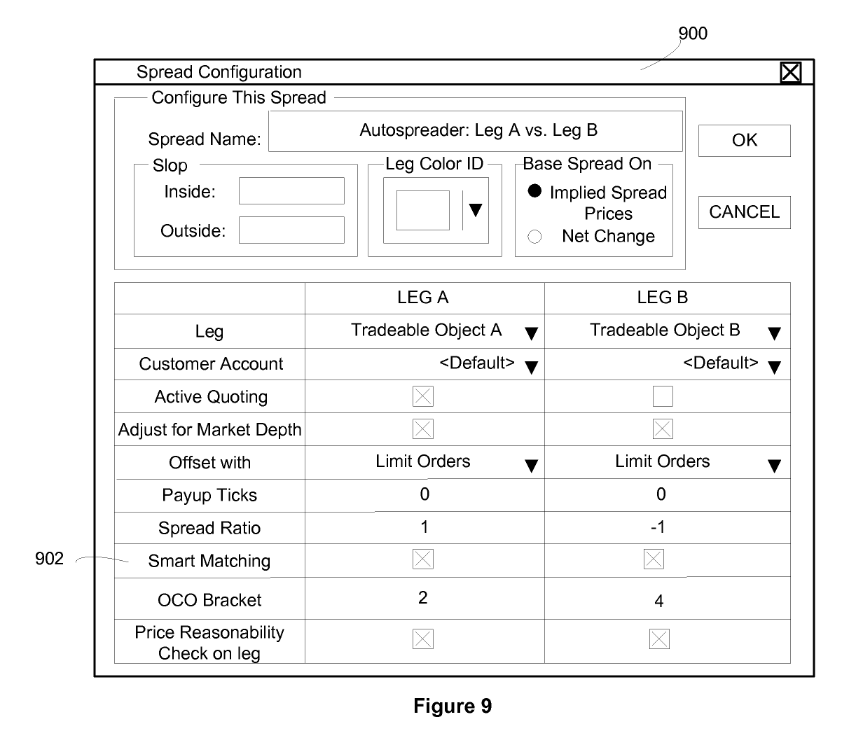

FIG. 9 illustrates an example of a spread configuration window 900. The spread configuration window 900 may be used to establish or set parameters of a synthetic spread, for managing a synthetic spread and/or for managing the legs of a synthetic spread individually. The parameters include inside and outside slop configuration, pricing choices, the legs of the spread, customer account, whether to adjust a leg, offsets, payup ticks, ratio for the synthetic spread, whether to check a price, whether a leg may be attached or detached, whether one or more legs of the spread may be eligible for smart matching, whether a spread itself may be eligible for smart matching and the like. The type and number of parameters to be established may vary.

A parameter may be set by entering a desired setting in a corresponding data entry area for the spread and/or leg of the spread, by selecting one or more options from a drop down menu, by selecting from an array or list of choices or radio buttons or the like. Additionally or alternatively, an order may be changed from being eligible for smart matching via a spread window, a window for the legged order, a window for the working order, and/or an indicator for the spread, the working order and/or legged hedge order. In the example of FIG. 9, both legs of the spread have been designated as eligible for smart matching by selection of the corresponding parameter 902. When identified as eligible for smart matching, the leg may be a basis for a comparison to a new order for matching the new order prior to submission of a new order. In addition or alternatively, a parameter may be set so that the trading tool compares all, some or select orders to a new order prior for matching to submitting the new order for trading. A description of a spread configuration window is provided in U.S. Pat. No. 7,437,325, titled “System and Method for Performing Automatic Spread Trading,” which is incorporated by reference herein in its entirety.

It will be apparent to those of ordinary skill in the art that methods involved in the system and methods described above may be embodied in a computer program product that includes one or more computer readable media. For example, a computer readable medium can include a readable memory device, such as a hard drive device, a CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals.

The claims should not be read as limited to the described order or elements unless stated to that effect. Therefore, all embodiments that come within the scope and spirit of the following claims and equivalents thereto are claimed as the invention.

1. A method for smart matching electronic orders for a tradeable object, comprising:
comparing a new working order to at least one pending order prior to submitting the new working order to an electronic exchange for trading, where the new working order is for a first quantity for a tradeable object and the pending order is for a second quantity for the tradeable object, the new working order and the at least one pending order derived from at least one common trading strategy of one or more traders;
in response to comparing, determining that the new working order and the at least one pending order are contra orders and have a common price;
matching at least a portion of the first quantity of the new working order and at least a portion of the second quantity of the pending order; and
reporting a match of the working order and the pending order.

2. The method of claim 1 where matching comprises matching the first quantity of the new working order and at least a portion of the second quantity of the pending order via the computing device.

3. The method of claim 2 further comprising reporting a match of the first quantity of the new working order.

4. The method of claim 2 where the new working order derives from a synthetic spread order.

5. The method of claim 4 further comprising submitting a hedge order for trading, the hedge order being associated with the synthetic spread order.

6. The method of claim 1 further comprising submitting a message to the electronic exchange to delete the at least a portion of the second quantity.

7. The method of claim 1 further comprising sending a cancel/replace message to the electronic exchange to cancel and replace the pending order with a new pending order.

8. The method of claim 6 where the new pending order comprises a remainder of the second quantity not matched with the new working order.

9. The method of claim 1 where matching comprises matching at least a portion the first quantity of the new working order and the second quantity of the pending order.

10. The method of claim 9 further comprising reporting a match of the second quantity of the pending order.

11. The method of claim 9 where the pending order comprises a hedge order of a spread.

12. The method of claim 11 further comprising reporting a fill of the spread.

13. The method of claim 1 where the new working order comprises an outright order.

14. A computer readable medium having instructions stored thereon which when executed by a processor cause the processor to carry out acts comprising:
comparing a new working order to at least one pending order prior to submitting the new working order to an electronic exchange for trading, where the new working order is for a first quantity for a tradeable object and the pending order is for a second quantity for the tradeable object, the new working order and the at least one pending order derived from at least one common trading strategy of one or more traders;
in response to comparing, determining that the new working order and the at least one pending order are contra orders and have a common price;
matching at least a portion of the first quantity of the new working order and at least a portion of the second quantity of the pending order; and
reporting a match of the working order and the pending order.

15. The computer readable medium of claim 14 where the new working order derives from a synthetic spread order.

16. The computer readable medium of claim 15 where the acts further comprise submitting a hedge order for trading, the hedge order being associated with the synthetic spread order.

17. The computer readable medium of claim 14 where the acts further comprise submitting a message to the electronic exchange to delete the at least a portion of the second quantity.

18. The computer readable medium of claim 14 where the pending order comprises a hedge order of a spread.

19. The computer readable medium of claim 18 further comprising reporting a fill of the spread.

20. A method for smart matching for synthetic spreads, comprising:
an order monitor configured to compare a new working order of a trader to at least one pending order of the trader prior to submitting the new working order to an electronic exchange for trading, where the new working order is for a first quantity for a tradeable object and the pending order is for a second quantity for the tradeable object, and where the new working order and the at least one pending order derive from at least one common trading strategy of one or more traders;
a match engine configured to matching at least a portion of the first quantity of the new working order and at least a portion of the second quantity of the pending order via the computing device in response to determining that the new working order and the at least one pending order are contra orders and have a common price; and
an order record configured to report a match of the working order and the pending order via the computing device.
